(19) United States
(12) Patent Application Publication
(10) Pub. No.: US 2006/0004633 A1
(43) Pub. Date: Jan. 5, 2006

(54) Multinode traffic architecture and network for the exchange of internet advertising traffic

(76) Inventor: Douglas Ashbaugh, Nokomis, FL (US)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 11/172,893

(22) Filed: Jul. 5, 2005

Related U.S. Application Data
(60) Provisional application No. 60/584,857, filed on Jul. 2, 2004.

(51) Int. Cl. G06F 17/00

(52) U.S. Cl. 705/14

(57) ABSTRACT

A multinode traffic architecture and network for the exchange of internet advertising traffic includes independent Internet advertising exchanges that interact to exchange various forms of advertising by requesting ads and/or fulfilling, directly or indirectly, responses to ad requests. Each node contains subroutines and interface ports that can be set up to communicate with other nodes, or cooperative third party Internet exchanges, allowing the sharing of advertising inventory and other information related to the exchange and advertisers needs for properly and ethically displaying their websites.

This disclosure is based upon Provisional U.S. Application No. 60/584,857, filed Jul. 2, 2004.

The present invention relates to a network advertising exchange of the type described in U.S. application Ser. No. 11/086,283, filed Mar. 23, 2005, the content of which is incorporated by reference herein.

The Multinode Traffic Architecture and Network for the exchange of internet advertising Traffic of the present invention (hereinafter “MUTANT”) consists of independent Internet advertising exchanges that interact to exchange various forms of advertising by requesting ads and/or fulfilling, directly or indirectly, responses to ad requests. One of the advantages of this business model is the support of new (immature) exchange Nodes (businesses) that cannot substantiate enough real advertising traffic to support the delivery of advertising inventory during the new business startup period. There are many additional secondary benefits as outlined herein, which protects the advertisers' credits and the exchanges' inventory.

Each MUTANT Node contains subroutines and interface ports that can be setup to communicate with other Nodes, or cooperative third party Internet exchanges, allowing the sharing of advertising inventory and other information related to the exchange and advertisers needs for properly and ethically displaying their websites. This is beneficial to all Internet exchanges by collectively providing advertisers with the ability to display Internet-oriented advertising based on general or targeted category and zone oriented targeting criteria, allowing surfers to search for specifically categorized Internet content, and find it even if the local exchange that they are connected to does not currently have an advertiser that can provide such content. The advantage of the Interconnected Nodes is the expansion of quality ad inventory, making the startup and the on-going phases of operating a developing advertising exchange easier, less costly, of better quality, and the exchange capable of fulfilling ad requests that could not have been previously filled by any other existing exchange model.

The Interconnection of the exchange Nodes adds to the Internet surfers' experience by broadening the inventory of websites they will view during a given period of time, preventing boredom, burnout, or repetitive display of unwanted or recently viewed Internet ads as would be shown by prior architectures. This MUTANT model is different from all other exchanges in that the Internet surfer's experience of using the new MUTANT based systems is not limited to the advertising inventory of that particular MUTANT based (Interconnected) exchange Node.

The MUTANT architecture has the capacity to display any form of Internet content (including advertising), and has the capacity to connect to any Internet exchange (including advertising) through a controlled and monitored, optionally secure, controlled communications port. In addition, all communications ports on the MUTANT system have optional features, including logging capabilities (supporting data mining), security (passwords, credentials, and encryption), and firewall capability (blockable by IP address).

Each Mutant Node has the capability of collecting aggregate information from other directly connected MUTANT Nodes during normal request activity, or during the processing of special information requests. This has the advantage over all existing Internet exchange technologies of collecting, and optionally algorithmically profiling, the traffic characteristics for all subordinate, peer, or sponsoring Nodes, allowing automation of traffic category determination (which is beneficial from a financial and business planning perspective). This capability also minimizes the amount of labor involved in operating a MUTANT Node, by automating processes that are currently manual in nature on all other systems. For instance, the MUTANT system allows thresholds to be set that, once reached, trigger activity in the system such as traffic category and zone determination, for exchange inventory purposes. The MUTANT system does this automatically, on-the-fly, in a dynamic fashion resulting in the MUTANT system automatically reconfiguring itself, or mutating, to the benefit of MUTANT operators and customers, over time.

MUTANT Nodes connect logically over a network, such as the Internet, to share advertising responsibility using either socket based or TCP/IP communications. The protocols supported include, but are not limited to, Hypertext Transport Protocol (HTTP), Secure Hypertext Transport Protocol (HTTPS), File Transfer Protocol (FTP), Universal Datagram Protocol (UDP), Secured Socket Layer (SSL), or Transport Layer Security (TLS), Node connections over TCP/IP.

The MUTANT Nodes can send requests across TCP/IP secure or unsecure communications paths or channels, depending on how the operators of each MUTANT Node agree to set the level of communication between their two Nodes, which may include percentage of transactions and/or security protocols. The MUTANT Nodes have multiple, selectable levels of encryption, with optional checksum and programmable algorithm seed (salt), for use on a per data path or channel basis. The MUTANT Nodes can be configured such that each is statistically biased to communicate a certain percentage of transactions through each communications port, or none at all. The algorithm for determining how the transactions are allocated to each port can be made more complex, or less complex. It is mentioned herein for completeness in the overall description of the MUTANT architecture related to the distribution of transactions.

The business model for this Interconnected Network of MUTANT Nodes is the first to allow the sharing of Internet advertising inventory residing in separate physical exchange systems.

Any MUTANT Node can monitor the quality of traffic requests coming from any connected MUTANT Node and gather or derive key technical data such as the rate of requests, internet IP addresses, and remote internet IP addresses, to determine if the remote Node is being attacked, directly or indirectly. The MUTANT architecture has the ability to determine an attack at two levels of depth from the perspective that if a website tied to a subordinate MUTANT Node is attacked, the IP address referer information to the website is passed from the subordinate Node to the auditing and/or sponsoring Node for further recognition and analysis. The MUTANT architecture detects AutoSurf activity, IP Blast activity, and enables protection from other forms of attack. This elevates traffic analysis and quality control to a new level in the Internet advertising industry.

AutoSurfs are defined as any script, system, piece of software, or technological discovery that initiates browser views or simulated website views of web pages, or any form of auto-pilot surfing which causes the number of credits in any advertiser's account to change without human involvement or intervention. In other words, AutoSurfs can include, but are not limited to, any type of browsing that does not require human involvement in the form of physical interaction with the computer between views, or where a web page can be left open and automatically refreshed without human intervention or physical stimulation, or by any other technology that bypasses a human being's involvement in the process of changing the number of credits in any advertiser's account.

Special features of the MUTANT system include the MUTANT system induces advertising by sending standard browser instructions to the surfer's web browser which induces the display of two or more unmodified advertisers websites simultaneously in a single browser window (as described in patent application Ser. No. 11/086,283) without using interstitial techniques. All prior art uses interstitial, banner images, iframe displays, or multiple browser window techniques (pop up, pop under, sliding ad windows) to display an advertiser's ad or website. The system allows advertisers to select various modalities of display for their website advertisement, including but not limited to, vertical screen splits, horizontal screen splits, and of varying proportions (example: display of 2, 3, or 4 websites in a single browser window).

The MUTANT system is a fully cookie independent architecture. The system does not require any cookies (whether client side or server side) for the proper operation and delivery of banner advertising, traffic, and other content.

The MUTANT ad delivery is different in an additional way from other forms of Internet advertising in that the surfer does not have to induce the full viewing of more than one website by click-stream induction. As compared to other forms of advertising such as banner ads (interstitial), pop ads (fractional/separate windows), sliding ads (fractional separate windows or layers), that when presented require the surfer to click the ad to display the ultimate website or enhanced ad details, the MUTANT system delivers the fully unmodified and ultimate website (or advertisement page) during the initial advertisement dispatch instructions sent to the browser. This is accomplished by inducing the web browser's natural http capability to fetch a predetermined set of website URLs as defined by the advertiser(s).

In summary, the MUTANT architecture is the first multinode Internet traffic/advertising exchange system to provide support for new exchange Nodes (businesses), monitor quality through optionally secure communication, protect the entire Network and it's reputation from attack, and allow alarm reporting. This architecture may also operate as a stand-alone Node. It is enabled for the interconnection to third party qualified traffic services, and automates the display of Internet ads and websites in a transparent fashion to the end user and advertiser from the various Nodes in the Network. From an surfer and advertiser perspective, the connection of the Nodes in the network effectively logically combines the Nodes into one massive advertising system, transparent to the Internet consumer.

Salient features of the MUTANT architecture include:
the advertisement is the actual display of the advertiser's website in an unmodified form, which enables the architecture to support advertising delivery of any technology supported by Internet web browsers. i.e. the MUTANT architecture is not limited to the delivery of any browser capable ad technology (the advertisement instruction delivered to the surfers browser may even be a URL that is simply a download link or other Internet application);
no consumer oriented information is required to deliver advertising;
no consumer oriented tracking information is recorded, this protects the user's privacy completely;
tracking cookies are not inserted into the surfer's browser;
no special media player is required to display the advertising;
ad is selected on a category or geographic zone basis;
ads are displayed on a human induction basis (not time based or automatic);
distributed induction of ad requests caused by human beings;
the system directs internet browsers to display a website (ad) by one or more levels of indirection as no content resides on or at the Nodes: this level of indirection is achieved by the Node only directing a surfers web browser to view a third party advertisers website;
the Nodes are not limited to any geographic territory (despite what the names may apply) and may focus on any one or more industries, distinct from other nodes
interstitial advertising is not induced in any way;
the system does not concern itself with the amount of time each ad is displayed, but focuses on the fact that each ad is actually displayed and such ads may remain on the surfer's browser indeterminately while the surfer is viewing each of the ads in detail, as the ads remain on the surfer's screen in a separate browser window during the detail viewing process, allowing the surfer to return to the original ads: this advertising system has characteristics of ad presentation that are commonly referred to as “sticky” advertising.

What is claimed is:

1. A multip-node advertising exchange, comprising a plurality of exchange servers on a network, each of said exchange servers being responsive to a request for desired content to retrieve advertising information from an advertiser's network site and transmit the retrieved information to a requesting device, said exchange servers being interconnected to one another such that a given server which does not have direct access to an advertiser's site can obtain requested content from another exchange having such access and provide said content to a requesting device.
